(19) United States
(12) Patent Application Publication
(10) Pub. No.: US 2016/0218447 A1
(43) Pub. Date: Jul. 28, 2016

(54) CABLE LUG DEVICE HAVING A CURRENT BAR, AND CONNECTION TERMINAL

(71) Applicant: PHOENIX CONTACT GMBH & CO. KG, Blomberg (DE)

(72) Inventors: Ralf BECKMANN, Detmold (DE); Andreas WENDT, Berlin (DE)

(21) Appl. No.: 15/023,443

(22) PCT Filed: Aug. 27, 2014
(86) PCT No.: PCT/EP2014/068145

§ 371 Date: Mar. 21, 2016

(30) Foreign Application Priority Data
Sep. 23, 2013 (DE) 10 2013 110 476.2

(51) Int. Cl. H01R 4/28; H01R 4/48; H01R 4/18; H01R 13/629

(52) U.S. Cl. CPC H01R 4/28; H01R 13/629; H01R 4/4809; H01R 4/183

(57) ABSTRACT

A cable lug device includes a cable lug body and a cable receptacle provided thereon to attach a connecting cable, and a current bar which is provided on the cable lug body for insertion into a receptacle of a connecting terminal, where it serves as a current bar for contacting a conductor.

### CROSS-REFERENCE TO PRIOR APPLICATIONS

This application is a U.S. National Phase application under 35 U.S.C. §371 of International Application No. PCT/EP2014/068145, filed on Aug. 27, 2014, and claims benefit to German Patent Application No. DE 10 2013 110 476.2, filed on Sep. 23, 2013. The International Application was published in German on Mar. 26, 2015 as WO 2015/039844 A1 under PCT Article 21(2).

### FIELD

The present invention relates to a cable lug device comprising a current bar and to a connecting terminal which is equipped with such a cable lug device for connecting at least one conductor.

### BACKGROUND

The prior art discloses various connecting terminals which are also suitable for connecting conductors having a large diameter. Connecting terminals of this kind are in particular also used in the high-voltage range, in which pulse currents of up to 80,000 amperes may occur.

The construction and manufacture of suitable connecting terminals is dependent on the price of the connecting terminal and in particular on the safety thereof. Connecting terminals may experience contact difficulties at individual clamping transition points which can lead to localised heating of the connecting terminal. In the worst case scenario, said terminal can even catch fire.

### SUMMARY

A cable lug device includes a cable lug body and a cable receptacle provided thereon to attach a connecting cable, and a current bar provided on the cable lug body for insertion into a receptacle of a connecting terminal for contacting a conductor.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a perspective view of a connecting terminal in the contact position and the open position;

FIG. 2 is a schematic perspective view of an individual electrical connecting terminal;

FIG. 3 is a schematic perspective view of a cable lug device for an electrical connecting terminal;

FIG. 4 is a schematic perspective view of another cable lug device for an electrical connecting terminal;

FIG. 5 is a schematic side view of the electrical connecting terminal in the open position;

FIG. 6 shows the insertion device and the clamping spring of the connecting terminal according to FIG. 1 and 2;

FIG. 7 is a perspective view of the actuation device of the connecting terminal according to FIG. 1;

FIG. 8 is a schematic side view of the electrical connecting terminal in an intermediate position; and

FIG. 9 is a sectional view of the intermediate position according to FIG. 8;

FIG. 10 is a highly schematic side view of the electrical connecting terminal in the clamping state; and

FIG. 11 is a perspective view of the electrical connecting terminal comprising a connected cable lug device.

### DETAILED DESCRIPTION

A cable lug device according to the invention comprises a cable lug body and a cable receptacle provided thereon for attaching a connecting cable. A current bar is provided or formed on the cable lug body and is formed and designed to be inserted into a current bar receptacle of a connecting terminal, where it serves as a current bar for contacting a conductor.

In particular, the current bar of the cable lug device and the electrical connecting terminal are suitable for connecting conductors having large cross sections. In this case, the electrical connecting terminal can be provided and suitable for conductors having small cross sections, but also in particular for conductors having cross section of up to 25 mm² or even 50 mm².

The cable lug device according to the invention has many advantages since it is both cost-effective and allows for simple and safe operation of an electrical connecting terminal. The cable lug device according to the invention and an electrical connecting terminal equipped therewith significantly increases operational safety. The number of clamping transition points can be reduced since one clamping transition point is dispensed with. The cable lug device comprises, on the cable lug body, specifically one cable receptacle for attaching and electrically contacting a connecting cable. The cable lug body comprises a current bar which is intended to serve as a current bar of an electrical connecting terminal. The cable receptacle of the cable lug device serves to connect the cable in an electrically contacting manner.

In conventional connecting terminals, however, cables are clamped against the respective current bars at either end thereof. In this case, the conductors of the cables to be connected are often provided with crimp sleeves or the like, and therefore there is a first transition resistance of the individual conductors to the crimp sleeve and a second transition resistance of the crimp sleeve to the current bar and at least one additional transition resistance of the current bar to the crimp sleeve of the other conductor, until the transition resistance of the crimp sleeve to the individual conductors of the other cable eventually occurs in turn. The invention reduces the number of transition resistances by at least one, and thus reduces said number considerably. If transition resistances then only occur at three points instead of four as before, the number of transition resistances is reduced by 33%.

Since the cable lug body of the cable lug device is also directly used as a current bar, the number of transition resistances and therefore the risk of a defect is significantly reduced. In addition, the cable lug device and the connecting terminal can be constructed in both a simple and cost-effective manner.

It is particularly preferred for the current bar of the cable lug device to be integral with the cable lug body. In particular, the current bar is made of the same material as the cable lug body. The cable lug body is preferably at least in part made of copper or a copper-containing alloy. The cable lug body can, as a whole, consist of a bent and folded-over metal sheet made of a copper alloy.

In preferred embodiments, the cable receptacle comprises a tubular connection portion. The tubular connection portion can be formed as a tube receptacle or as a sleeve or can comprise at least one receptacle or sleeve. In particular, the cable receptacle is formed as a crimp connection and is suitable for connecting a connecting cable by crimping.

The current bar preferably comprises a longitudinal portion on which in particular two layers are folded over on one another such that the longitudinal portion is twice as thick as the metal sheet. The abutment edge preferably extends in the centre of a transverse face and is formed in particular on the bearing surface of a conductor to be connected.

Preferably at least one transverse groove is provided in the current bar. A transverse groove in the current bar can be formed as a clamping groove and can be used to mould or locally push in an electrical conductor to be contacted. If, for example, a clamping lever or another clamping object presses against the conductor arranged between the current bar and the clamping object from the side of the clamping groove, the conductor deforms locally at the clamping groove and is moulded into the clamping groove in accordance therewith. As a result, the pull-out resistance of the conductor clamped to the current bar is significantly increased.

In preferred embodiments, the current bar comprises at least one insertion aid on its insertion side. The insertion aid can in particular enclose an insertion radius at the front end of the current bar. The insertion radius can be formed at least in part by the metal sheet that forms the current bar being bent or folded over at the front end of the current bar. This results in a rounded insertion aid in the insertion direction.

Moreover, a receiving groove for an anti-penetration unit is preferably provided in the current bar. A receiving groove of this kind for example allows an anti-penetration unit to be laterally inserted in order to prevent a conductor passing through a connecting terminal. Moreover, a receiving groove can also serve to fix the current bar and therefore the cable lug device to the electrical connecting terminal. For example, a bar, metal sheet or a stop element can be inserted from the side through an opening in the terminal housing, which bar, metal sheet or stop element is received in the groove and thus fixes the current bar and the cable lug body as a whole in the terminal housing.

The cable lug body preferably comprises at least one protruding guide element, such as a laterally protruding guide nose, guide ridge or the like. By means of one or in particular at least two guide elements which are spaced apart from one another, the cable lug body can be retained and positioned on the connecting terminal in a precise and also reproducible manner.

In preferred embodiments, the current bar is at least twice as long as the cable receptacle. In this embodiment, the current bar is preferably between approximately 50% and 90%, and preferably between 60% and 75% the length of the cable lug body.

It is possible and preferable for the current bar to be wider and flatter than the cable receptacle. A wide and flat current bar having the same volume and therefore the same conductivity as a narrow current bar provides a considerably larger bearing surface and therefore contact surface.

In preferred embodiments, the cable lug device comprises an elongate cable lug body. In other preferred embodiments, the cable lug body is designed to be shorter such that the overall length of the current bar is only between approximately ⅓ and ½ the length of the cable lug body.

In simple embodiments, the cable lug device, which is formed as one piece overall, consists of a sheet metal strip which is bent in the shape of a tube and is folded over in the region of the current bar such that the current bar has a flat and rectangular cuboid cross section.

In advantageous embodiments, at least one fixing opening is provided on the bottom side of the cable lug body and in particular on the bottom side of the current bar. In a fixing opening of this type, the current bar and therefore the cable lug device can be fixed in general to the connecting terminal in a simple manner by means of a fixing lug or the like. The fixing opening can be used to receive any fixing element and can be locked by means of the fixing element, for example.

Moreover, the invention also relates to a connecting terminal comprising at least one conductor receptacle and at least one clamping device, and comprising a current bar receptacle, the current bar receptacle being formed and designed to receive a current bar of a cable lug device such that a cable can be connected to the conductor receptacle in an electrically conductive manner by the current bar of the cable lug device by means of the clamping device.

Such a connecting terminal according to the invention is in particular equipped with at least one conductor receptacle, at least one clamping device and at least one current bar receptacle. The current bar receptacle is suitable for receiving a current bar of a cable lug device. The cable lug device comprises a cable lug body and a cable receptacle provided thereon for attaching a connecting cable. The current bar is provided on the cable lug body. The current bar of the cable lug device can be received in the current bar receptacle and is used for contacting a conductor.

A connecting terminal according to the invention also has many advantages. The connecting terminal according to the invention is suitable for fixedly receiving a cable lug device with an exact fit, as described above. In this case, the receiving device comprises a current bar receptacle with an exact fit for receiving the cable lug device. Here, the cable lug body can be inserted into the electrical connecting terminal together with the current bar in order to provide the current bar at that point. Therefore, when all the parts are connected there are considerably less transition resistances in the electrical connecting terminal according to the invention than in electrical connecting terminals from the prior art, in which cables are connected at either end of the connecting terminal.

Two or more different cable lug devices can be connected to a single electrical connecting terminal. For example, a cable lug device can be connected by a relatively short cable lug body, while a cable lug device can alternatively also be connected by a cable lug body in which the current bar is at least twice as long as it is in the short cable lug body. This makes it possible to use a short cable lug device in which the two connected cables are led into the electrical connecting terminal at the same height. Alternatively, a cable lug device having a short cable lug body can also be used, in which the cable connected to the cable lug device is connected to be lower than or offset in height (or to the side) from the cable connected to the current bar of the cable lug device inside the electrical connecting terminal. In this embodiment, the two connected cables are offset. This can be advantageous in terms of installation space and increases the flexibility of use.

With regard to the elongate cable lug body in which the current bar is twice as long as the cable receptacle or longer, the cable connected to the cable receptacle can likewise be deflected to the same degree.

A support is preferably provided, on which the current bar of the cable lug device is retained. The clamping device preferably comprises at least one clamping spring for exerting the clamping force. A pivotable clamping lever is used in particular to clamp the conductor. In this case, the clamping spring preferably comprises a first leg and at least one second leg. The clamping spring is hingedly coupled to the clamping lever by means of the first leg in particular. The clamping spring is preferably hingedly coupled to the auxiliary lever by means of the second leg. The auxiliary lever and the clamping lever are advantageously pivotally arranged on the support.

An electrical connecting terminal of this kind has many advantages and allows for a construction comprising fewer components and simple components. Due to the fact that, in preferred embodiments, the support has a frictional fit by means of the clamping lever, clamping spring and auxiliary lever, the relatively small number of structurally simple components makes an even higher clamping force and an even greater opening angle possible. In one specific embodiment, clamping forces of 800 Newtons or even 1200 Newtons were measured. In most applications, this is more than necessary, and therefore the clamping forces may also be advantageously reduced in the design.

The support can also be referred to as a clamping body and is used to retain the current bar and to pivotally attach the clamping lever.

The electrical connecting terminal according to the invention provides a tilting lever terminal having dynamic lever transmission. The electrical connecting terminal can be formed in particular as a connecting terminal and can serve as the lead-through in a wall of an electrical installation or a wall or the like.

In the open state, an opening angle between the current bar and the clamping edge is preferably at least 45°. The opening angle or rather the maximum opening angle is, in particular, larger than 60° and preferably larger than 75°. Opening angles of 90° or more than 90° are possible and preferable. Large opening angles and a pivoting-in region which is freely accessible at the top allows for simple assembly even of conductors having large cross sections, since the conductors can be pivoted into the connecting terminal in a simple manner from “above”, i.e. from the side opposite the current bar. There is no need to bend the conductors, which are generally rigid, and push them back in order to then insert the conductor into the connecting terminal from the front.

A first pivot pin and at least one second pivot pin which is spaced apart from said first pivot pin are preferably provided on the clamping lever. In particular, the clamping spring comprises a first pin receptacle and at least one second pin receptacle which is spaced apart from said first pin receptacle. The auxiliary lever is preferably equipped with a first rotary unit and at least one second rotary unit spaced apart from said first rotary unit. This means that the clamping lever, the clamping spring and preferably the auxiliary lever each have two separate joints spaced apart from one another.

The clamping lever is preferably pivotally attached to the support by means of the first pivot pin. In particular, the first pin receptacle of the clamping spring is provided on the first leg of the clamping spring and the second pin receptacle of the clamping spring is provided on the second leg of the clamping spring. The first pin receptacle of the clamping spring arranged on the first leg is preferably coupled to the second pivot pin of the clamping lever.

The first rotary unit of the auxiliary lever advantageously comprises a pin which is pivotally connected to the second pin receptacle on the second leg of the clamping spring. In particular, the second rotary unit of the auxiliary lever is pivotally arranged on the support.

The second rotary unit of the auxiliary lever preferably has a rounded outer contour which is pivotally received in a matching rounded clearance in the support. Both the outer contour and the clearance are particularly preferably circular or a circular-segment-shaped. In particular, the second rotary unit of the auxiliary lever is pivotally or rotatably retained, and preferably supported, on the rounded outer contour of the support.

It is possible and preferable for the second rotary unit of the auxiliary lever to comprise an opening into which a guide pin is inserted. In this case, the second rotary unit can be rotatably mounted in the opening by means of the guide pin. However, it is also possible for the guide pin in the opening to substantially only be used for guidance and not to transmit forces. For example, the guide pin can be part of the housing and consist of a plastics journal, for example, which is pivoted or clipped into the opening. However, it is also possible for the guide pin to be a pin on the support or to be inserted separately into the support in order to pivotally retain and/or support the auxiliary lever on the second rotary unit.

In all embodiments, the clamping spring is preferably part of an actuation device. In a simple embodiment, the actuation device only consists of the clamping spring. The clamping spring preferably serves two functions: the clamping spring is used to exert the clamping force and simultaneously also serves as an actuation lever.

At least one tool opening is preferably provided on the actuation device in order to insert a tool and actuate the electrical connecting terminal, so as to clamp an electrical conductor or to release the clamp again, for example.

The actuation device preferably comprises a tool receptacle. The tool receptacle can be provided on an insertion device. It is possible and preferable for the clamping spring to have, for example, a substantially C-shaped cross section, and for the inner region of the cross section to be occupied by the insertion device at least in part. The tool receptacle can be provided on the insertion device and serves as a counter bearing during actuation in order to transmit the actuation forces.

The insertion device can be made of plastics material, for example. However, the tool receptacle and/or a counter bearing may also be provided by tabs or the like bent over on the clamping spring.

The internal diameter of the tool opening is preferably larger than an internal diameter of the tool receptacle. This creates many possibilities since different angles of the tool receptacle on the insertion opening can be provided for different geometries and uses of the electrical connecting terminal, for example. Depending on the accessibility and geometric conditions, the tool receptacle can be oriented on the insertion opening at different angles with respect to the surface of the tool opening in the clamping spring. Different insertion devices therefore allow for a different configuration of the overall connecting terminal. By exchanging just one single component, a larger number of possible uses can be provided, without substantially increasing the storage requirements for parts.

The tool receptacle in or on the insertion device preferably extends transversely to the current bar or the current bar receptacle. In the open state, the angle between the tool receptacle and the current bar can vary and is dependent on the intended use.

The actuation device and in particular the clamping spring preferably act on the clamping lever by means of the auxiliary lever.

In simple embodiments, the actuation device consists practically only of the clamping spring in which the tool opening is provided. It is also possible for a lever extension or the like to be provided on the clamping spring such that it is also possible to actuate the connecting terminal without additional tools.

In particularly preferred embodiments, the clamping spring acts as a tension spring at least in the clamping state. In particular, the clamping spring is substantially relieved of tension at least in the open state. The clamping spring is particularly preferably fully relieved of tension in the open state. Within the context of the present invention, the term “substantially relieved of tension” in particular means an active force which is less than 10% and preferably less than 5% the maximum intended clamping force.

In all embodiments, it is preferable for the clamping lever to be behind a dead centre when in the clamping state. This first requires an application of force in order to move the clamping lever from the clamping state back into the open position. This leads to self-securing or self-locking of the clamping state and increases safety. This is preferably implemented by it being possible for the clamping spring acting as a tension spring to slightly retract again before the clamping state is reached, relieving the tension slightly.

In all embodiments, it is preferable for the end of the first leg and/or the end of the second leg of the clamping spring to each be bent in order to form the first and/or the second pin receptacle in each case. This allows for simple manufacture of the clamping spring and reliable functioning.

In particularly preferred embodiments of the invention, at least the support, the clamping lever and the auxiliary lever are formed as punched bent parts. This allows for particularly simple and cost-effective manufacture and assembly.

At least one anti-penetration unit is preferably provided, which prevents a received conductor from penetrating the connecting terminal. An anti-penetration unit of this kind can, for example, consist of a part which is received in a groove in the current bar and is inserted into the support from the outside through appropriate holes and is therefore securely retained on the support.

In conductors having large cross sections of 20 mm², 25 mm², 30 mm² or 35 mm², after a conductor of this kind has been clamped for the first time and removed, zero clamping is possible, in which a thin conductor having a diameter of 1 mm, 0.5 mm or less can also then be reliably clamped by the clamping lever.

When moving the electrical connecting terminal from the open state into the clamping state, the clamping lever is first largely closed either without force or practically without force, before a high clamping force is applied as the tool is pivoted further.

The structure and function of a cable lug device 300, which is equipped with a current bar 310, and a connecting terminal 100, which is supplied with power by means of the cable lug device 300 comprising a current bar 310, are explained hereinafter with reference to the accompanying drawings. The connecting terminal 100 is formed as a lead-through terminal in this case and is used to connect a cable to an electrical apparatus, for example.

During assembly, the cable lug device 300 together with the current bar provided thereon is placed in the connecting terminal 100 first, followed by a conductor 126 to be connected, which is clamped between the clamping device of the connecting terminal 100 and the current bar 310. The current bar 310 of the cable lug device 300 is supported on the support 108 in the process.

In this case, FIG. 1 shows two perspective views of a connecting terminal 100 side by side, specifically in the clamping state or in the contact position 145 on the left and in the open state or in the open position 144 to the right thereof.

The connecting terminal 100 comprises a terminal housing 150 and is intended to rest against a wall of an electrical installation by means of the bearing portion 172. The conductor receptacle 115 is largely closed when in the contact position 145, while in the open position 144 a particularly large opening angle 146 of up to 75° or more is created. This also allows a conductor to pivot into the conductor receptacle 115, which, in particular for conductors having a cross section of several square millimetres, can significantly simplify the connection.

The terminal housing 150 consists in particular of an electrically non-conductive material and preferably of a plastics material. The bearing portion 172 can be provided as a peripheral ridge, by means of which the connecting terminal 100 is supported peripherally against a wall. The bearing portion 172 may also consist of a plurality of segments or individual supporting elements.

In both the contact position 144 and the open position 145, the tool opening 109 provided in the actuation device 103 is visible on the connecting terminal 100. The actuation device 103 comprises a cover housing in the form of a cover 153. The cover 153 consists of an insulating material in this case and protects the inside of the actuation device 103, and also protects the inside of the connecting terminal 100 against mechanical contact. The clearance and creepage distances are also significantly increased by the cover 153.

The terminal housing 150 can comprise an outer housing 170 and an inner housing 160 on which the support 108 is retained. The support 108 is preferably made of metal, and in particular from a punched bent part. The outer and inner housing preferably consist of a plastics material. During assembly, the support 108 is retained on the inner housing 160 and the required metal and clamping parts are assembled. The inner housing and the support 108 form a pre-assembled unit which then only has to be placed in the outer housing 170, or inserted or locked into an outer housing which is already present on an electrical installation where, for example, it is integral with the wall.

The connecting terminal 100 comprises the pivotable actuation device 103. By pivoting the actuation device 103, the connecting terminal can be opened or closed again. When pivoting the actuation device 103, a gap can be formed between the peripheral wall of the bearing portion 172 and the cover 153 of the actuation device 103, specifically at the point at which the closure ridge 149 is present in the contact position 145. If the actuation device 103 is pivoted backwards out of the closed position shown on the left in FIG. 1, the closure ridge 149 is pivoted through the wall into the electrical installation. At the same time a gap is formed between the wall 172 and the cover 153 at the point at which the closure ridge 149 was previously arranged. When the actuation device is pivoted further into the open position 144, the gap is ultimately closed again by the deflector 155 so that there is no gap in the open position. The gap is at a spacing from the conductor receptacle 115 and is independent of the conductor receptacle 115.

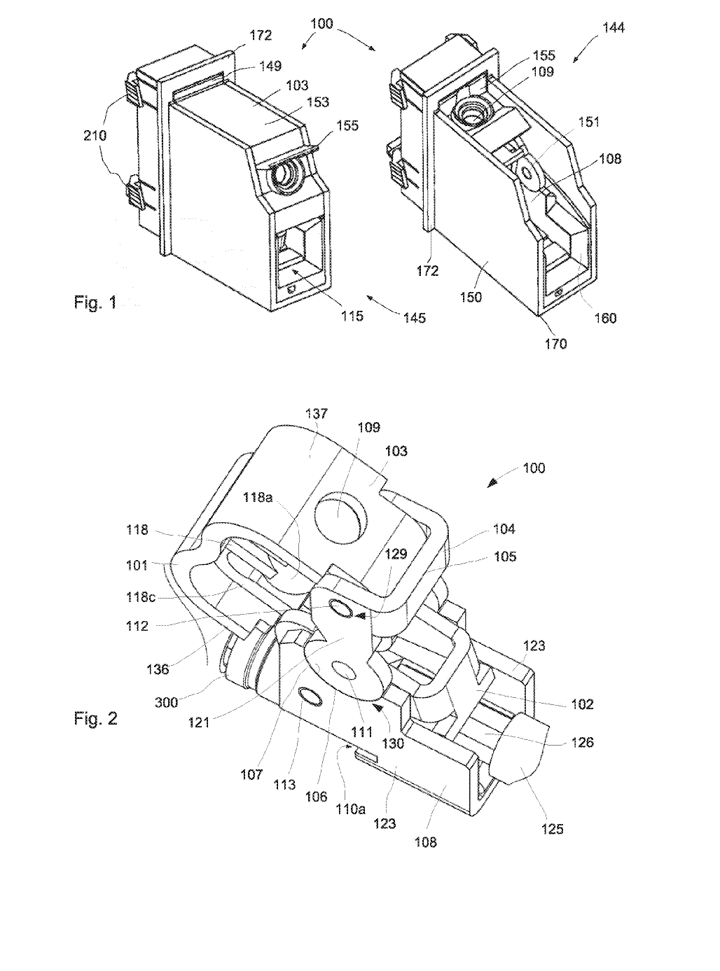

FIG. 2 is a schematically enlarged perspective view of an individual electrical connecting terminal 100, in which the housing 150 has been omitted to better illustrate and identify the individual components.

The electrical connecting terminal 100 comprises a support 108 having two lateral walls 123, which in general has an approximately U-shaped cross section. The current bar 310 of the cable lug device 300 is removably retained on the support 108. The current bar 310 is provided on the cable lug device 300 and is an integral component of the cable lug body 301.

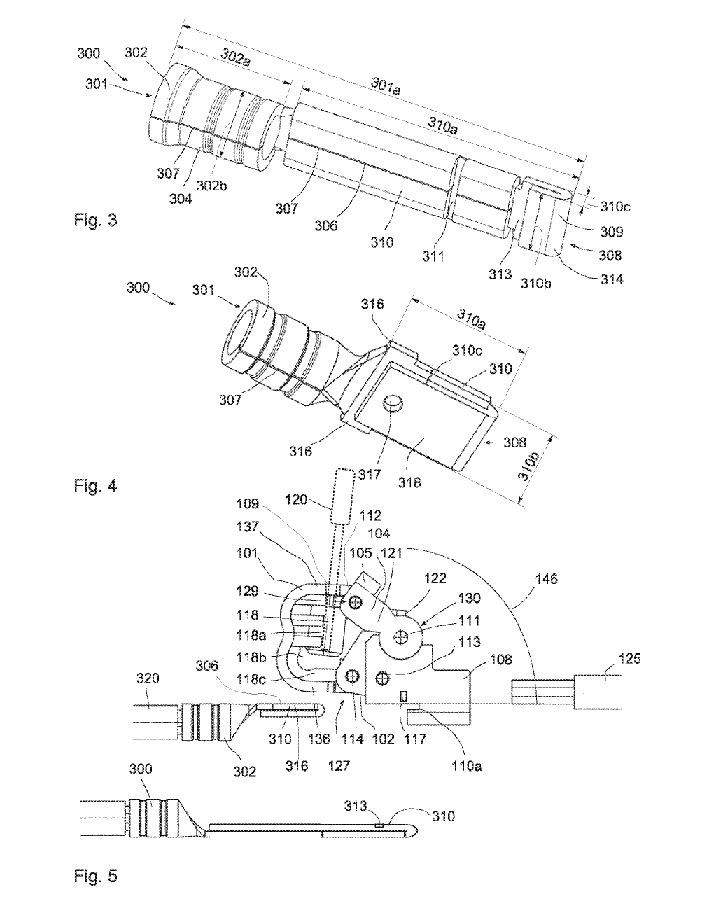

An anti-penetration unit 117 can be arranged in a groove 311 (cf. FIGS. 3 and 5), which means prevents penetration by an inserted conductor 126, and additionally protects the current bar 310 and the cable lug device 300 inside the support 108.

The electrical connecting terminal 100 further comprises a clamping lever 102 which is pivotally retained on the support 108 by means of a first pivot pin 113. The clamping lever 102 comprises a second pivot pin 114 (cf. FIG. 5) which is spaced apart from the first pivot pin 113. One end of a first leg 136 of the clamping spring 101 is pivotally retained on the second pivot pin 114.

With the first leg 136 and the second leg 137, the clamping spring 101 is generally approximately C-shaped. The clamping spring 101 is pivotally retained or mounted on the pin 112 at the end of the second leg 137. The pin 112 forms part of the first rotary unit 129 at a first end of the auxiliary lever 104. The auxiliary lever 104 consists of two parallel side walls 121 which are interconnected by means of a cross connector 105. When viewed from the front, the cross connector 105 is approximately U-shaped so as to allow the second leg 137 of the clamping spring 101 to pivot on the first rotary unit 129 of the auxiliary lever 104. The auxiliary lever 104 is likewise a single-piece punched bent part.

A second rotary unit 130 is provided at the second end of the auxiliary lever 104. In this case, the second rotary unit 130 comprises a central hole 111 into which a plastics journal (not visible in FIG. 2) in the form of a guide pin 151 of the housing 150 (cf. FIG. 1) engages in order to guide the second rotary unit 130. However, the second rotary unit 130 may also be rotatably mounted at the hole 111.

In this case, the second rotary unit 130 and therefore the auxiliary lever 104 are pivotally mounted by means of the round external shape 107, which is received in the round recess 106. The virtual axis of rotation extends through the centre of the opening 111. When the auxiliary lever 104 is pivoted, the round external contour 107 of the second rotary unit 130 rotates about the virtual axis of rotation inside the round recess 106 in the support 108. This allows for effective force transmission in what is the vertical direction in this case, i.e. in a direction transverse to the current bar 310.

The clamping spring 101 with its overall approximately C-shaped side profile comprises an insertion device 118 inside the “C”, which device is in the form of a plastics insert 118 in this case and serves, inter alia, as a counter bearing for a tool 120 when the connecting terminal 100 is actuated. The clamping spring 101 is subjected to tension in this case such that, when subjected to tension, the two legs 136 and 137 of the clamping spring 101 move away from one another.

The clamping spring 101 also serves as the actuation device 103 or as the actuation lever in this case, and comprises the insertion device 118 as well as the clamping spring 101.

A tool opening 109 is provided on the second leg 137 of the clamping spring 101, through which opening a tool 120 (cf. FIG. 5) such as a screwdriver can be inserted in order to move the connecting terminal 100 from the open state 144 into the clamping state 145 and back again by the movement of the screwdriver.

Two different variants of a cable lug device 300 are shown in FIGS. 3 and 4. In this case, FIG. 3 shows a longer variant. The overall length 301a of the cable lug device 300 is substantially made up of the length 302a of the cable receptacle and the length 310a of the current bar 310. A tubular portion, in which a central receiving opening is provided for receiving a cable to be connected, is provided on the cable receptacle 302. The cable receptacle 302 has a length 302a, a width 302b and height 302a. In preferred cases and in the embodiment, the cable receptacle is substantially rotationally symmetrical such that the width 302b also corresponds to the height 302c and therefore to the diameter 302b. The connection portion, which is designed as a crimp connection 304 in this case, is provided on the cable receptacle.

The current bar 310 extends axially next to the cable receptacle 302. In this case, the current bar 310 extends over a length 310a which, in the embodiment, is more than twice as long as the length 302a of the cable receptacle 302. The current bar 310 comprises two layers folded over one another across at least one longitudinal portion 306 and in particular the length 310a. The abutment edge 307 is provided on the upper side of the current bar 310, on the surface that is in contact with a conductor 126 to be contacted.

In particular an insertion aid 309 is provided on the insertion side 308. While the layers of the current bar 310 are folded over in the longitudinal direction across the longitudinal portion 306, the insertion aid 309 can be formed by a portion of the current bar 310 folded over along the insertion edge. As a result, an insertion radius 314 is formed on the insertion side 308, which radius considerably simplifies the insertion process.

The current bar 310 consists in particular of a copper alloy or a copper-containing alloy and is suitable for conducting high amperages. The current bar 310 has a width 310b and a thickness or height 310c. In this case, the width 310b is considerably larger than the height 310c. In addition, the width 310b is larger than the diameter 302b of the cable receptacle and the height 310c is smaller than the diameter 302b of the cable receptacle 302. This provides a large contact surface for a conductor 126 for a given material volume.

In this case, the length of the current bar 310 is such that the cable receptacle 302 is so far away from the insertion side 308 that the cable receptacle 302 and the connecting cable 320 connected thereto are so far from the clamping spring and the actuation device that there is no interference with a pivoting movement from the open position 144 into the clamped position 145 and vice versa. In this variant of the cable lug device 300, a conductor 126 to be connected and the cable 320 retained on the crimp connection 305 are at the same height and can have a continuous virtual axis.

FIG. 4 shows another variant of the cable lug device 300, in which the overall length is considerably shorter since the current bar 310 has a length 310a which approximately only corresponds to the length 302a of the cable receptacle 302. The cable receptacles 302 of the cable lug devices according to FIGS. 3 and 4 are in particular identical.

In the variant according to FIG. 4, the bottom side 318 of the current bar 310 is visible. The receiving opening for a cable 320 to be connected is arranged on the back of the current bar in this case. This means that a conductor 126 resting against the upper side of the current bar 310 is transversely offset from the cable 320, which is connected to the receiving opening in the cable receptacle 302.

A fixing unit 317 is provided on the bottom side 318 of the current bar 310 in the form of a hole or a receiving opening, and is used to lock with a corresponding retaining nose or the like on the support 108. Guide lugs 316 or guide ridges are provided at the side on the current bar 310 and ensure that the cable lug device as a whole and the current bar 310 are retained in a specific manner on the connecting terminal 100.

In this case, the current bar is again formed of two layers which are folded over one another but which are bent at the front edge on the insertion side 308 on account of the shorter length 310a of the current bar.

In this case too, the width 310b of the current bar is greater than the diameter 302b of the cable receptacle, while the thickness 310c of the current bar is considerably smaller than the diameter 302b of the cable receptacle 302.

FIG. 5 is a side view of the electrical connecting terminal 100 in the open state 144. The two cable lug devices 300 are shown by way of example in FIG. 5 in order to illustrate the possible uses of the two cable lug devices 300 according to FIG. 3 and FIG. 4. Neither of the two cable lug devices is connected to the connecting terminal 100 yet. If the shorter cable lug device 300 is connected, the cable 320 is located on the crimp connection 305 below the current bar, while the cable 125 on the other side of the connecting terminal is led in above the current bar. If, on the contrary, the longer variant of the cable lug device 300 is connected, both cables 320 and 125 are arranged above the current bar and may extend in a continuous line. In order to allow the clamping spring 101 and the actuation device 103 to pivot, the current bar is configured to be longer so that the cable receptacle 302 only extends upwards from the connecting terminal 100 to a distance where the pivot movement is not affected.

The receiving opening 132 or the wall in the insertion device 118 which surrounds the receiving opening 132 serves as a counter bearing during actuation using a tool 120 (shown by a dotted line). The insertion device 118 comprises an insertion body 118a, an in particular resilient holding leg 118c and a gap 118b therebetween. This allows the insertion device 118 to rest against the two legs 136, 137 of the clamping spring 101, even during spring movements. The holding leg 118c can be rigidly connected to the first leg 136 of the clamping spring 101 or clamped thereon.

A current bar receptacle 110a is provided on the connecting terminal 100. One of the two cable lug devices 300, which are again shown at a spacing from the connecting terminal 100 in FIG. 5, can optionally be connected to the current bar receptacle 110a. The selection can depend on the local spatial conditions and the connection geometry.

For assembly purposes, the front insertion side 308 of the cable lug device 300 and therefore of the current bars 310 is inserted into the current bar receptacle 110a in the connecting terminal 100. The radius on the insertion side of the current bar facilitates the insertion. The current bar 310 is guided in the connecting terminal 100 with precision and is positioned in a specific manner by means of the guide elements 316 in the form of guide noses or guide ridges on either side. The cable lug device 300, which comprises a crimp sleeve in the form of a crimp connection 305, is therefore already connected to the connecting terminal 100 together with the cable 320 crimped thereto.

On the other side, a cable 125 is then inserted into the connecting terminal 100 by means of a conductor 126. The conductor(s) 126 of the cable 125 rest on the upper side of the current bar 310 of the cable lug device 300 after having been inserted or pivoted-in. The overall wide and flat current bar 310 also provides a sufficient contact surface on the folded-over longitudinal portion 306 for the transmission of high amperages.

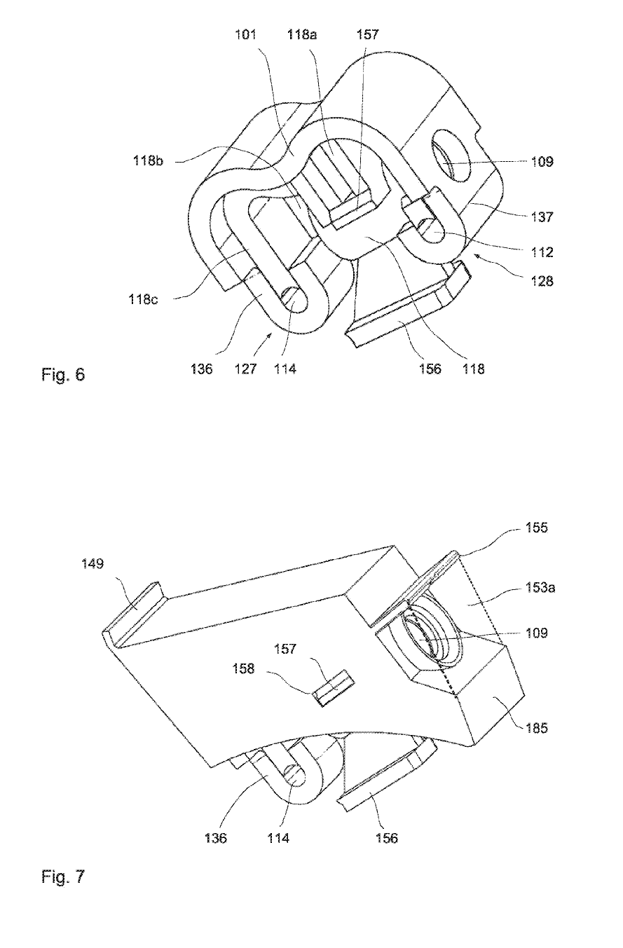

FIG. 6 shows the insertion device 118 on the clamping spring 101. The clamping spring 101 provides the connecting terminal 100 with the required clamping force. The clamping spring 101 is subjected to tension in this case such that, when subjected to tension, the two legs 136 and 137 of the clamping spring 101 move away from one another. The “C” is open in the direction of the conductor receptacle 115. In addition to the clamping spring 101, the actuation device 103 comprises the plastics insert and the cover 153 shown in FIG. 7. The second pivot pin 114 on the first leg 136 of the clamping spring 101 and the pin 112 on the second leg 137 are visible. The projections 157 lock with the openings 158 in the cover 153. The planar anti-insertion means 156 is connected to the insertion body 118a, in particular integrally, by means of a connecting piece.

FIG. 7 shows the clamping spring 101 together with the insertion device 118 and the attached cover 153. On the lower end, the closure ridge 149 can be seen at the back and the deflector 155 can be seen at the top. If side walls are provided, as indicated by the dashed lines, an insertion funnel is provided for a tool.

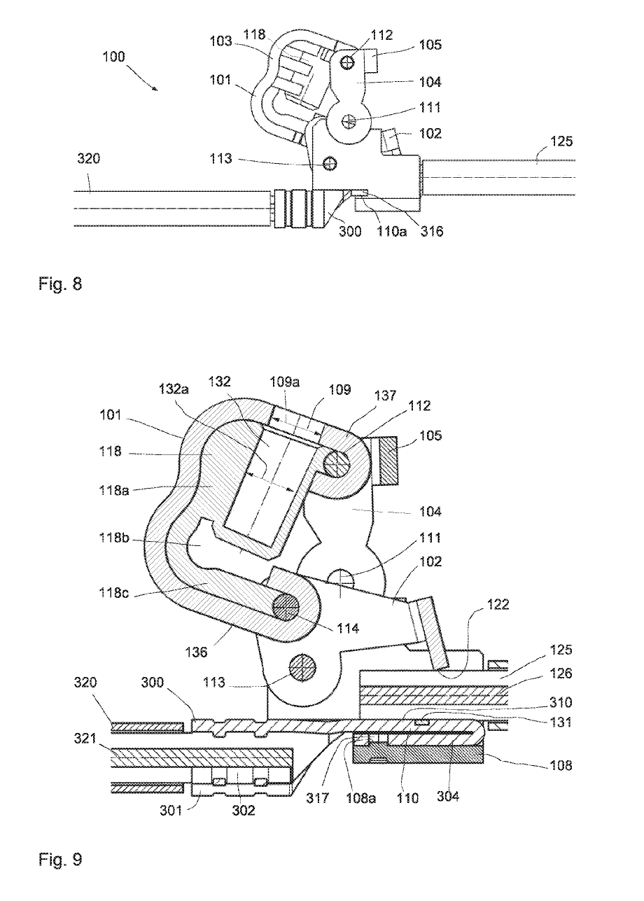

FIG. 8 is a schematic side view of the connecting terminal 100 together with an insertion device 118 and the cable lug device 300 retained on the connecting terminal 100 in an intermediate position between the open position 144 (cf. FIG. 5) and the closed position 145. Only the support 108 is shown, while the terminal housing 150 is not shown in FIG. 8. The electrical connecting terminal 100 is moved from the intermediate position shown in FIG. 8 into the clamping state 145 by pivoting the clamping spring 101 clockwise, i.e. towards the clamping lever 102.

FIG. 9 shows the same intermediate position as in FIG. 8. However, FIG. 9 shows a section through the connecting terminal 100 and the insertion device 118 retained thereon, and through the cable lug device 300 comprising the current bar 310. It can be seen here that the clamping lever 102 comprising the clamping edge 122 has already been pivoted to such an extent that the clamping edge rests against the conductors 126 of the cable 125. The clamping force is substantially further increased when the clamping lever 102 is pivoted further.

In order to be able to identify the other components more effectively, the anti-insertion means 156 having the connecting piece has been omitted from the view in this case. A receiving opening 132 for receiving a tool 120 (cf. FIG. 5) is provided in the insertion device 118. In this case, an internal diameter 109a of the tool opening 109 in the clamping spring is provided with a larger diameter than the internal diameter 132a of the receiving opening 132 in the plastics insert 118. This allows the clamping spring 101 to be provided for use with different insertion devices 118 or with plastics inserts having different receiving openings 132. This allows different connecting terminals 100 to be provided, in which only the insertion device 118 is different and thus the operating angle changes.

The clamping lever 102 comprises two parallel side walls, between which the clamping edge 122 is provided. The clamping lever 102 is also formed as a single-piece punched bent part in this case.

Furthermore, a groove 131 is provided in the current bar 110 of the cable lug device 300 and is arranged at the point at which the clamping edge 122 presses an inserted conductor 126 against the current bar 310. As a result, during the clamping process, conductors 126 can be deformed into the groove 131 such that effective pull-out protection can be provided.

In the sectional view according to FIG. 9, the first pin receptacle 127 can be seen on the first leg 136 of the clamping spring 101 in section. In this case, the first pin receptacle 127 of the clamping spring 101 engages around the second pivot pin 114 of the clamping lever 102. The second pin receptacle 128 of the clamping spring 101, which engages around the pin 112 of the first rotary unit 129 of the auxiliary lever 104, can be seen in section at the other end of the clamping spring 101, in particular on the second leg 137.

The cable lug device 300 comprises a fixing opening 317 on the bottom side of the current bar. During insertion, a snap-in nose 108a of the support 108 locks into the fixing opening 317 such that the current bar 310 is retained on the connecting terminal 100 in a fixed but releasable manner.

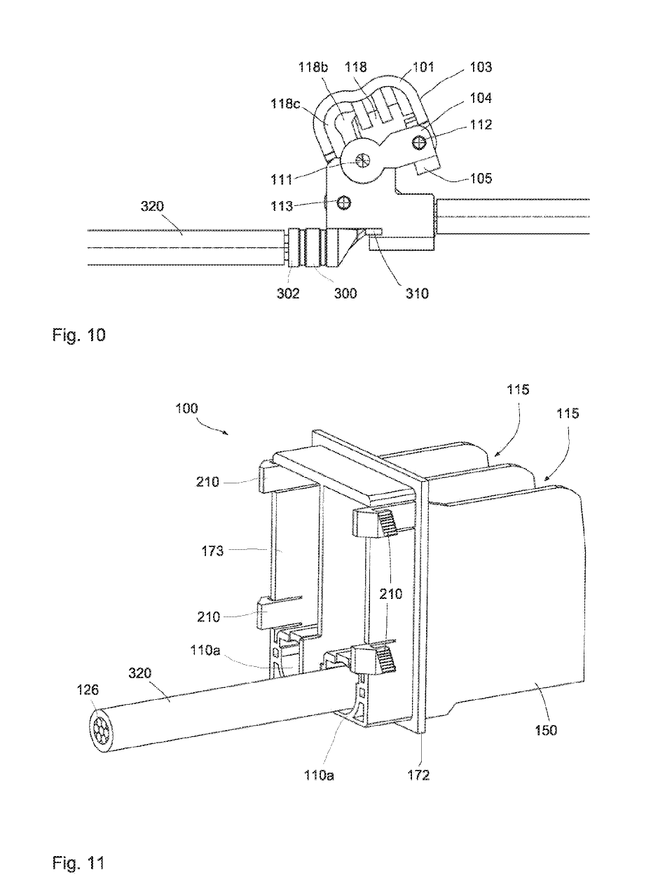

FIG. 10 shows the clamping state 145. The clamping spring 101 is pivoted even further and provides the required clamping force. In this case, the clamping spring 101 has been pivoted beyond a dead centre such that, to be released, force has to first be exerted. In this position, clamping forces of from 800 to 1200 Newtons are easily achievable.

The function of the electrical connecting terminal 100 will be explained in the following with reference to FIGS. 5, 9 and 10.

A cable lug device 300 having a suitable overall length 301a is first selected. The selection is also made on the basis of the geometric conditions of the installation situation. The cable lug device 300 is inserted into the current bar receptacle 110a of the connecting terminal 100 by means of the insertion side 308 and is positioned by means of the guide noses or guide ridges 316 with great precision.

FIG. 8 schematically shows a cable 125 comprising an electric conductor 126. In the views according to FIG. 8 to 10, various parts of the electrical connecting terminal 100 have been omitted in order to better illustrate the function. A fixing unit in the form of a snap-in nose 108a or a retaining nose on the support locks into a hole in a fixing unit 317 on the current bar 310 such that the current bar 310 is securely retained on the connecting terminal 100.

FIG. 9 shows an intermediate state in which the clamping lever 102 has already been pivoted considerably. This is done by a tool being inserted into the tool opening 109 in the clamping spring 101 and being pivoted clockwise in the view according to FIGS. 5, 9 and 10. When moving from the state shown in FIG. 5 into the state shown in FIG. 9, the pivot movement is carried out practically without force since the distance between the two legs 136 and 137 of the clamping spring 101 does not change or practically almost does not change and therefore the spring tension does not change, resulting in easy operation.

In conductors having very large cross sections, in the state shown in FIG. 9, the clamping edge 122 can almost already be resting against the conductor 126, as also shown in FIG. 9. When moving from the state in FIG. 5 into the state shown in FIG. 9, the clamping lever 102, the clamping spring 101 and the auxiliary lever 104 each pivot in a manner coupled to one another.

In the clamping state 145 shown in FIG. 10, zero clamping can be achieved, in which conductors having even the smallest cross section can be clamped. In this case, the clamping edge rests in the groove 131 in the current bar 310. During pivoting from the state shown in FIG. 9 into the clamping state 145 according to FIG. 10, the clamping spring 101 is tensioned, the distance between the first leg 136 and the second leg 137 increasing. A high clamping force is therefore generated as a result of the stable clamping spring 101.

FIG. 10 shows a self-locked state. During pivoting of the clamping spring 101 and the auxiliary lever 104, a dead centre was passed and therefore the clamping spring 101 is slightly relieved of tension in the clamping state 145 in relation to the maximum pre-tension. A stable state is achieved as a result. In this self-locking state, a connecting line 119 extends between the pin 112 and the second pivot pin 114 just below the centre of the hole 111 or the virtual axis of rotation of the second rotary unit 130 of the auxiliary lever 104. As a result, when the connecting terminal is moved into the open state 144, the clamping spring 101 first has to be further pre-tensioned in order to pass the dead centre.

FIG. 11 is a schematic perspective view of a connecting terminal 100 according to the invention, comprising two conductor receptacles 115 for connecting two conductors 125. The connecting terminal 100 comprises two current bar receptacles 110a, into each of which in this case a single current bar 310 of a cable lug device 300 comprising a crimped cable 320 can be inserted. The current bar receptacles 110a receive the cable lug devices 300 at the insertion end such that they are each protected on all sides. As a result, the cable lug device 300 comprising the crimped cable 320, including the cable insulation surrounding the conductor(s) 126, can be inserted into the current bar receptacle 110a such that live parts are received in a touch-proof manner. This creates simple and very effective protection against fingers coming into contact therewith. The air and leakage paths are also markedly increased. For this purpose, the current bar receptacles 110a preferably each comprise a sleeve-shaped housing portion, into which a cable lug device 300 is inserted during assembly together with the associated current bar 310. Two or more current bar receptacles 110a and associated conductor receptacles 115 may be provided on a housing 150. The individual conductor receptacles 115 are preferably separated by a partition wall, and therefore each conductor receptacle 115 is surrounded by a U-shaped housing portion, and this allows for simple pivoting in of a conductor 125 to be connected, and provides a large air path and leakage path.

Overall, an advantageous electrical connecting terminal 100 is provided. The electrical connecting terminal 100 designed as a tilting lever terminal comprises a dynamic lever transmission, in which, at the beginning of the closing process, the clamping edge 122 covers a large distance and in which, during further closing using less force, a relatively longer distance is covered by means of the tool, which is converted into a high clamping force. The current bar 310 is provided by means of an exchangeable cable lug device 300. The number of clamping transitions is reduced as a result.

The maximum opening angle 146 can be very large such that even the most solid conductors can be pivoted into the pivoting-in region 115 which is open at the top.

Settling in the spring or other components is reliably prevented and in principle clamping forces of any size can be exerted by means of suitably selecting the wall thicknesses of the clamping spring 101 and the additional dimensions.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

Connecting terminal 100
Clamping spring 101
Clamping lever 102
Actuation device 103
Auxiliary lever 104
Cross connector 105
Recess 106
External shape 107
Support 108
Fixing unit 108a
Tool opening 109
Current bar receptacle 110a
Hole 111
Pin 112
Pivot pin 113,114
Conductor receptacle 115
Anti-penetration unit 117
Insertion device 118
Insertion body 118a
Gap 118b
Support leg 118c
Tool 120
Side, wall 121
Clamping edge 122
Side, wall 123
Cable 125
Conductor 126
Pin receptacle 127, 128
Rotary unit 129, 130
Groove 131
Receiving opening 132
Diameter 132a
Leg 136,137
Open state 144
Clamping state 145
Opening angle 146
Closure ridge 149
Housing, terminal housing 150
Journal, guide pin 151
Cover 153
Tool access 153a
Deflector 155
Anti-insertion means 156
Projection 157
Opening 158
Inner housing 160
Outer housing 170
Bearing portion, bearing wall 172
Wall 173
Locking unit 210
Cable lug device 300
Cable lug body 301
Length 301a
Cable receptacle 302
Length 302a
Width 302b
Crimp connection 304
Longitudinal portion 306
Abutment edge 307
Insertion side 308
Insertion aid 309
Current bar 310
Length 310a
Width 310b
Height 310c
Transverse groove 311
Clamping groove 313
Insertion radius 314
Guide nose 316
Fixing unit, hole 317
Bottom side 318
Cable 320

1. A cable lug device, comprising:
a cable lug body and a cable receptacle provided thereon for attaching configured to attach a connecting cable; and
a current bar provided on the cable lug body and configured to be inserted into a receptacle of a connecting terminal.

2. The cable lug device of claim 1, wherein the current bar is integral with the cable lug body.

3. The cable lug device of claim 1, wherein the cable receptacle comprises a tubular connection portion and is formed as a crimp connection.

4. The cable lug device of claim 1, wherein the current bar comprises at least one folded longitudinal portion.

5. The cable lug device of claim 1, wherein at least one transverse groove is provided in the current bar.

6. The cable lug device of claim 1, wherein a clamping groove configured to mould in a conductor is provided in the current bar.

7. The cable lug device of claim 1, wherein the current bar comprises an insertion aid on an insertion side thereof, which aid encloses an insertion radius.

8. The cable lug device of claim 1, wherein the current bar comprises a receiving groove for an anti-penetration unit.

9. The cable lug device of claim 1, wherein the cable lug body comprises at least one laterally protruding guide nose.

10. The cable lug device of claim 1, wherein the current bar is at least twice as long as the cable receptacle and is wider and flatter than the cable receptacle.

11. The cable lug device of claim 1, wherein at least one fixing unit is provided on a bottom side of the cable lug body and on a bottom side of the current bar to fix the current bar to the connecting terminal.

12. A connecting terminal, comprising:
a conductor receptacle;
at least one clamping device;
a current bar receptacle; and
a cable lug device having a cable lug body and a cable receptacle provided thereon configured to attach a connecting cable, and comprising a current bar provided on the cable lug body,
wherein the current bar is received in the current bar receptacle.

13. The connecting terminal of claim 12, further comprising a clamping spring for configured to exert a clamping force and a pivotable clamping lever configured to clamp a conductor.

14. The connecting terminal of claim 13, wherein the clamping spring comprises a first leg and at least one second leg, is hingedly coupled to the clamping lever by the first leg, and is hingedly coupled to an auxiliary lever the second leg, wherein the clamping lever and the auxiliary lever are pivotally arranged on a support.

15. The connecting terminal of claim 14, wherein, on the clamping lever, a first pivot pin is pivotally attached to the support and is arranged above at least one second pivot pin which is spaced apart from said first pivot pin, the clamping spring has a first pin receptacle and at least one second pin receptacle which is spaced apart from said first pin receptacle, and the auxiliary lever has a first rotary unit and at least one second rotary unit which is spaced apart from said first rotary unit.

16. The connecting terminal of claim 15, wherein the first pin receptacle of the clamping spring is provided on the first leg of the clamping spring, and the second pin receptacle of the clamping spring is provided on the second leg of the clamping spring.

17. The connecting terminal of claim 15, wherein the first rotary unit of the auxiliary lever comprises a pin which is pivotally connected to the second pin receptacle of the second leg of the clamping spring, and the second rotary unit of the auxiliary lever is pivotally arranged on the support.

18. The connecting terminal of claim 13, wherein the clamping spring is part of an actuation device, and the actuation device comprises at least one of a tool opening or a tool receptacle on an insertion device.

19. The connecting terminal of claim 18, wherein the actuation device is configured to act on the clamping lever via the auxiliary lever.

20. The connecting terminal of claim 13, wherein the clamping spring is configured to at least one of act as a tension spring when in a clamping state or is substantially relieved of tension when in an open state.
